(19) United States
(12) Patent Application Publication
(10) Pub. No.: US 2004/0029242 A1
(43) Pub. Date: Feb. 12, 2004

(54) Process for immobilizing an enzyme

(75) Inventors: Ming Tang, Fairfield, OH (US); Yan Chen, Beijing (CN); Xiaoqing Wang, Beijing (CN); Xin Fu, Beijing (CN)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH

(21) Appl. No.: 10/637,126

(22) Filed: Aug. 8, 2003

Related U.S. Application Data
(60) Provisional application No. 60/402,280, filed on Aug. 9, 2002.

(51) Int. Cl. C11D 3/386

(52) U.S. Cl. 435/174; 510/320; 510/226

(57) ABSTRACT

A process for immobilizing an enzyme includes the steps of selecting a supporting substrate, activating the supporting substrate with an activating molecule to form an activated supporting substrate; adding an enzyme and the activated supporting substrate to an organic solvent to form a mixture and obtaining an immobilized enzyme from the mixture. The organic solvent contains from about 0.01% to about 30% by weight of the organic solvent of water.

### CROSS REFERENCE TO RELATED APPLICATION

This application claims the benefit of U.S. Provisional Application No. 60/402,280, filed Aug. 9, 2002.

### FIELD OF THE INVENTION

The present invention relates to a process for immobilization of an enzyme and the use of the immobilized enzyme.

### BACKGROUND OF THE INVENTION

Enzymes are used on an industrial scale and have been used in detergent products for a long time. These enzymes are expected to help remove stains from hard or soft surfaces such as clothes, dishes or floors. In general, these stains which can be treated by enzymes contain a protein, a starch, and/or a lipid which is originally from food or body soils. Thus, proteases, amylases and/or lipases have been formulated into detergent products to help decompose these stains.

In order to remove stains, these enzymes typically first need to deposit onto the stains, and second, need to open their conformation to reveal the active site to hydrolyze these stains. After that, detergent solutions (e.g. surfactants) remove the hydrolyzed stain fragments. During the hydrolyzing step, it is important to reveal the active site of the enzyme and make them contact stains, otherwise, even though the total amount of enzyme is increased, it may not increase stain hydrolysis performance. For instance, it has been found that lipase requires a hydrophobic-hydrophilic interface in order to open its conformation and thereby reveal the active site. While the lipid-wash solution interface is clearly solid-liquid, the kinetics of opening at this interface has been shown to be quite slow. Thus, it may take a relatively long time for lipase to open its conformation and reveal the active site even once it contacts the stain. In a washing cycle, however, there is very limited time for lipase to open its conformation and thus, the benefit through the wash cycle may not be as complete as possible, even if large amounts of lipase are added.

Attempts to solve this issue have involved immobilizing an enzyme onto a substrate such as zeolite, or silica and thereby lock open the conformation to more easily hydrolyze stains. This may be done by preparing an emulsion having a continuous hydrophobic phase and a dispersed aqueous phase in which enzymes and carriers are dispersed, and then removing water from the dispersed phase until the phase turns into solid enzyme coated particles. However, in this method, enzyme conformation changes might occur even though these factors are allegedly optimized when the emulsion is prepared. However, it has now been found that during the water removal step, the ratio of hydrophobic phase to hydrophilic (aqueous) phase changes and thus, the enzyme conformation changes again and it does not remain optimized. As a result, although enzymes may be attached to carriers physically, their conformation is not always optimized. Furthermore, immobilized enzymes prepared by this method are incompatible with aqueous washing environment as they will fully dissolve in the wash solution, thus eliminating the immobilization benefit.

Accordingly, there is a need for an improved enzyme immobilizing method which insures that the enzyme's active site conformation remains open.

### SUMMARY OF THE INVENTION

The present invention is directed to a process for immobilizing an enzyme. The process comprises steps of; selecting a supporting substrate, activating the supporting substrate with an activating molecule to form an activated supporting substrate, adding an enzyme and the activated supporting substrate is dissolved into an organic solvent, and obtaining an immobilized enzyme. The organic solvent contains from about 0.01% to about 30% by weight of the organic solvent of water. Also, the present invention is directed to an immobilized enzyme which is immobilized by the process. Furthermore, the present invention is directed to a cleaning composition comprising the immobilized enzyme.

The present invention provides a process of immobilizing an enzyme having an optimized conformation to react with a substrate. According to the process of the present invention, enzyme conformation of is optimized in the organic solvent/water interface and then chemically bound to the supporting substrate. Thus, in any in-use-condition, the immobilized enzyme of the present invention quickly opens its conformation to reveal the active site and thus, it more easily contacts stains to hydrolyze them. As a result, the immobilized enzyme of the present invention provides improved performance even at low concentration. In addition, as it is possible to reduce the enzyme level in a detergent composition while providing at least parity performance, and alternatively may provide improved performance at a given enzyme level. In addition, the present invention provides a significant financial savings when using a large amount of enzyme in industries. Moreover, the present invention provides an enzyme system compatible with aqueous washing environment.

All documents cited are, in relevant part, incorporated herein by reference; the citation of any document is not to be construed as an admission that it is prior art with respect to the present invention.

### DETAILED DESCRIPTION OF THE INVENTION

The following is a list of definitions for terms used herein. “Comprising” means that other steps and other ingredients which do not affect the end result can be added. This term encompasses the terms “consisting of” and “consisting essentially of”.

The process of the present invention comprises the steps of (a) selecting a supporting substrate, (b) activating the supporting substrate with activating molecule to form an activated supporting substrate, (c) adding an enzyme and the activated supporting substrate to an organic solvent and (d) obtaining an immobilized enzyme.

(a) Selecting a Supporting Substrate

The supporting substrate of the present invention is a substrate to which an enzyme immobilize. Typical supporting substrates of the present invention are particles, preferably selected from inorganic particles, however, some organic particles can also be used. A more preferred supporting substrate herein is selected from the group consisting of a silica particle, a zeolite, an aluminum oxide, an organic polymer having either a carboxyl or an amino group, and a mixture thereof. These organic polymers are, preferably, selected from the group consisting of a polyacrylic acid, a polymaleic acid, a poly peptide, chitosan and a mixture thereof. Preferably, the supporting substrate has a median particle size (as measured as the diameter of the particle) of from about 1 nanometer to about 10 micrometers, more preferably, from about 1 nanometer to about 1 micrometer and even more preferably, the supporting substrate is selected from a silica having a particle size of from about 5 nanometers to about 1 micrometer. The median particle size is measured by SEM (Scanning Electron Microscope). A highly preferred silica is SiOx (MN1P, which is provided by Zhou Shan Ming Ri Nano Material Company (Zhejiang Province, China). Other preferred supporting substrates are described in PCT patent publication No. WO 90/04181 which is assigned to Nilsson, published on Apr. 19, 1990.

In addition, when an inorganic particle is selected as the supporting substrate, it must be modified by a linking molecule before being activated. Any compounds which can provide the substrate with either carboxyl and/or amino groups can be used as a linking molecule herein. A preferred linking molecule is a silane linking molecule, more preferably the structure of the silane molecule is R₁—(CH₂)ₙ₁—Si(O(CH₂)ₙ₂CH₃)₃, wherein R₁ is selected from —COOH or —NH₂; n1 is from about 1 to about 16, preferably from about 3 to about 8; n2 is from about 0 to about 10, preferably from about 0 to about 4. More preferably, the linking molecule of the present invention is 3-aminopropyltriethoxysilane (APS). The weight ratio of the linking molecule to the supporting substrate is preferably from about 0.001:1 to about 10:1, and more preferably from about 0.1:1 to about 5:1. Other linking molecules useful herein are described in U.S. Pat. No. 6,004,786 to Yamashita, et al., issued Dec. 21, 1999.

The linking molecule modifies the supporting substrate to connect the supporting substrate and the enzyme. It is therefore also preferred to add a functional group introducer together with the linking molecule to the supporting substrate. A preferred functional group introducer is a carboxylic group introducer or an amino group introducer, more preferably a carboxylic group introducer such as a carboxylic acid anhydride. It is conceivable that the linking molecule itself may sometimes work as the functional group introducer. For example, when selecting carboxylic silane as the linking molecule, an additional functional group introducer is not necessary.

The modification of the supporting substrate by the linking molecule or functional group introducer can be accomplished by mixing the supporting substrate with the linking molecule with functional group introducer into a common organic solvent such as toluene, and re-fluxing for from about 4 hours to about 7 hours, preferably about 6 hours. The refluxed mixture is extracted by filtration, washed with ethanol and dried at about 30° C. to about 70° C., preferably from about 45° C. to about 55° C., for 20 minutes. The mixture is preferably kept in the vacuum dry container until being applied to next step.

Preferred carboxylic acid anhydrides are selected from the group consisting of a succinic anhydride, a maleic anhydrides, or a mixture thereof. In order to link a carboxyl group onto the substrate, the substrate is usually dissolved in organic solvents, preferably, a mixture of pyridine and anhydrous diethylether, and is mixed with a carboxylic acid anhydride at 25° C., for 17 hours. After mixing, the mixture is extracted by filtration and washed with organic solvents, preferably, anhydrous diethylether is used. The obtained supporting substrate is applied to step (b).

(b) Activating the Supporting Substrate by an Activating Molecule

In this step, an activating molecule activates the supporting substrate from step (a) to connect or entrap an enzyme onto the supporting substrate. The activation is performed by adding an activating molecule to the supporting substrates from step (a) and stirring together for from about 30 minutes to about 60 minutes, at 4° C. A preferable activating molecule of the present invention is a water soluble carbon diimide. More preferably, the water soluble carbon diimide is selected from the group consisting of ethyl-3-(3-dimethyaminopropyl)-carbon diimide hydrochloride (EDC), a succinimide, and a mixture thereof. The weight ratio of the activating molecule to the supporting substrate is preferably from about 0.01:1 to about 1:1, more preferably, from about 0.05:1 to about 0.5:1. After the supporting substrate is activated, the supporting substrate is isolated by centrifuging the sample and decanting the supernatant.

(c) Adding an Enzyme with the Supporting Substrate into an Organic Solvent

This step immobilizes an enzyme onto the supporting substrate by adding the enzyme, with stirring, to the activated supporting substrate from step (b). Then, an organic solvent is added to the enzyme and supporting substrate to form a mixture, and emulsifying the mixture for at least about 15 hours at 4° C. Preferably, the organic solvent is added to enzyme and supporting substrate within about 10 minutes, more preferably within 1 minutes. The reason is that if we can emulsify enzyme solution in hexane quickly, more enzymes can be activated before it attaches onto supporting substrate. Otherwise, the enzyme may not been activated before it goes to the substrate. A preferred enzyme useful herein is selected from the group consisting of a cellulase, a hemicellulase, a peroxidase, a protease, an amylase, a mannanase, a xylanase, a lipase, an esterase, a cutinase, a pectinase, a keratinase, a reductase, an oxidase, a phenoloxidase, a lipoxygenase, a ligninase, a pullulanase, an arabinosidase, a hyaluronidase and a mixture thereof, more preferably a protease, an amylase, a lipase, a cellulase, a mannanase, a peroxidase and a mixture thereof. Particularly preferred enzymes useful herein are described in U.S. Pat. No. 6,376,447 to Boutique, et al., issued Apr. 23, 2002.

The organic solvent useful can be selected from any organic solvent that can form a visible interface with water. Preferred organic solvents are selected from the group consisting of hexane, toluene, a triglyceride, and a mixture thereof. Other preferred organic solvents useful herein are described in U.S. Pat. No. 6,025,171 to Fabian, et al., issued Feb. 15, 2000. The weight ratio of the enzyme to the supporting substrate is preferably from about 0.005:1 to about 10:1, and more preferably from about 0.025:1 to about 2.5:1. The liquid phase of the mixture in step (c) thus contains at least organic solvent and from about 0.01% to about 30%, and preferably from about 1% to about 25% by weight water. In order to construct an interface for an enzyme to open its active confirmation, dual interface (organic/water) is required. Thus, if a pure organic solvent (i.e., containing no water) is used, there is no interface at which the enzyme can open its conformation, and as a result, the enzyme can not be activated prior to immobilization. Thus the enzyme activity can not be improved.

(d) Obtaining the Immobilized Enzyme from the Mixture

After the enzyme is immobilized onto the supporting substrate, the reaction solution is separated with, for example, a separatory funnel. The water phase is usually centrifuged to separate the assembled enzyme from the reaction solution. This is typically accomplished by centrifuging at about 5000 rpm for about 30 minutes at a temperature of about 4° C. After decanting the supernatant, 15 ml buffer solution (phosphate buffer, 10 mM, pH=7.2) is usually added to redisperse and wash the sample. After washing, the sample is usually centrifuged again and the supernatant decanted. Typically, two additional wash cycles are completed using deionized (DI) water. The final product is preferably obtained by vacuum drying the solid obtained after the final centrifuge/decant cycle.

Assembled Enzymes

According to the process explained hereinabove, assembled enzymes of the present invention are obtained. These enzymes can be used for any purposes in which general enzymes are employed, such as cleaning compositions, food and beverages, etc.

Cleaning Compositions

The assembled enzymes of the present invention are preferably formulated into cleaning compositions with other ordinary ingredients such as surfactants, builders, buffers, bleaches and so on. Also, the cleaning compositions herein may also further include enzymes which are not assembled according to the present invention. These suitable ingredients or enzymes are described in, for example, U.S. Pat. No. 6,391,839 to Addison, issued May 21, 2002.

The following examples further describe and demonstrate the preferred embodiments within the scope of the present invention. The examples are given solely for the purpose of illustration, and are not to be construed as limitations of the present invention since many variations thereof are possible without departing from its spirit and scope.

### EXAMPLE 1

(1) Synthesis of APS Modified Silica Nano Particle

2 g of silica nano-sized particle (SNP), (size ca.50 nm, available from Zhou Shan Ming Ri Nano Material Company) is combined with 2 ml 3-aminopropyltriethoxysilane (APS, from Acros Organic Company, Geel, Belgium) and 25 ml anhydrous toluene in a round bottle flask and stirred. The mixture is then heated to reflux for 6 hours, extracted by filtration with filter paper and washed with ethanol. The resulting APS modified SNP is dried in an oven at 50° C. for 20 min, and stored in a vacuum dried container.

(2) Introduction of Carboxylic Acid Group

2.5 ml pyridine (10% v/v) is added to 22.5 ml anhydrous diethylether and stirred. 75 mg of succinic anhydride (30 mM) was added to the stirring solution and allowed to dissolve. 2 g of APS modified SNP from step (1) was added into the solution and stirred at 25° C. overnight (i.e., 17 hours). The sample was extracted by filtration with filter paper and sequentially washed on filter paper with anhydrous diethylether, 10 mM of EDTA and DI water, and vacuum dried at 4° C. for 4 hours to form the modified SNP. This introduces a carboxylic group onto the SNP to which the enzyme will be linked.

(3) Synthesis of Assembled Lipase

0.2 g succinic acid modified SNP is finely ground using a mortar and pestle. Then it is activated by adding it to 10 ml pH=7 phosphate buffer (10 mM) containing 0.03M EDC at 4° C. and stirred for 30 minutes. After 30 minutes, the mixture is centrifuged and the supernatant decanted.

The residue (activated SNP) is suspended in 10 ml pH=7 phosphate buffer (10 mM). 125 μl LIPOLASE™ 100 L is added into the solution (250 ppm enzyme in solution) and mixed. 90 ml hexane is quickly added into the solution within 2 seconds. The final solution is stirred at 4° C. overnight (for 17 hours).

(4) Obtaining an Immobilized Enzyme

The organic solvent in the solution from step (3) is separated with a separatory funnel. The water phase is centrifuged (Centrifuge, 5810R, from Eppendorf) at 5000 rpm, 4° C. for 30 minutes. After decanting the supernatant, 15 ml of buffer solution (10 mM phosphate buffer, pH=7.2) is added into the residue to redisperse and wash the sample. After washing the sample, it is again centrifuged and the supernatant decanted. Two additional wash cycles are completed using DI water. The final product is obtained by vacuum drying (Freeze Dryer, FD-5N, from Eyela) the solid obtained after the final centrifuging/decanting cycle.

### EXAMPLE 2

The assembled lipase from EXAMPLE 1 was formulated into a granular laundry detergent composition as per the following formulas.

| | | |
|---|---|---|
| Surfactant | | |
| Linear alkyl sulfate (anionic surfactant) | 23.35 | 22.41 |
| Cationic surfactant | 1.13 | 1.10 |
| Builder/Alkalinity | | |
| SKS6 | 5.67 | 1.46 |
| Silicate (80% active) | 11.22 | 10.99 |
| Maleic-acrylic acid co-polymer (45% active) | 23.00 | 22.53 |
| Buffers | | |
| Carbonate | 29.24 | 28.13 |
| Sulfate | 1.75 | 5.09 |
| Enzyme | | |
| Assembled lipase | 0.20 | 0.15 |
| Protease | 0.20 | 0.48 |
| Suds control | | |
| Silicone suds controlling agent | 0.32 | 0.71 |
| Additives | | |
| Brightener | 0.27 | 0.26 |
| Aesthetics | | |
| PEG4000 | 0.46 | 0.45 |
| Styrene xylene sulfate (40% active) | 5.67 | 2.85 |
| Perfume | 0.19 | 0.19 |
| minors | To 100% | To 100% |

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for immobilizing an enzyme, comprising the steps of:
(a) selecting a supporting substrate;
(b) activating the supporting substrate with an activating molecule to form an activated supporting substrate;
(c) adding an enzyme and the activated supporting substrate to an organic solvent to form a mixture; and
(d) obtaining an immobilized enzyme from the mixture,
wherein the organic solvent contains from about 0.01% to about 30% by weight of the organic solvent of water.

2. The process according to claim 1, wherein the supporting substrate is an inorganic particle.

3. The process according to claim 2, wherein the supporting substrate has a particle size of from about 1 nanometer to about 10 micrometers.

4. The process according to claim 2, wherein the process further comprises the step of modifying the supporting substrate with a linking molecule after the selecting step.

5. The process according to claim 4, wherein the linking molecule is a silane linking molecule.

6. The process according to claim 1, wherein the activating molecule is a water soluble carbon diimide.

7. The process according to claim 1, wherein the enzyme is selected from the group consisting of a protease, an amylase, a lipase, a cellulase, a mannanase, a peroxidase or a mixture thereof.

8. The process according to claim 1, wherein the organic solvent is selected from the group consisting of hexane, toluene, a triglyceride, and a mixture thereof.

9. An immobilized enzyme which is immobilized by the process according to claim 1.

10. A cleaning composition comprising the immobilized enzyme according to claim 9.
